(19) United States
(12) Patent Application Publication
(10) Pub. No.: US 2005/0252669 A1
(43) Pub. Date: Nov. 17, 2005

(54) Work machine with a formed beam frame

(75) Inventors: Richard J. LaReau, Decatur, IL (US); Geoff C. Mills, Champaigne, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar, Inc.

(21) Appl. No.: 10/845,185

(22) Filed: May 14, 2004

(51) Int. Cl. A01B 23/04

(52) U.S. Cl. 172/776

(57) ABSTRACT

A main frame for a work machine having a front section, a rear section, and an operator station. The main frame has a single formed beam operatively connecting the front section to the rear section. The operator station is connected to the main frame.

### TECHNICAL FIELD

The present invention relates generally to a work machine, and more particularly to a work machine having a main frame with a single formed beam.

### BACKGROUND

Work machines such as, for example, motor graders, may be used in earth leveling applications such as road maintenance or surface contouring. Motor graders have a front section and a rear section. The front section includes a steerable traction device, while the rear section typically includes a power source and an operator station supported by a fixed traction device. A main frame connects the front and rear sections to one another. The main frame also supports a blade that performs the leveling operations.

The main frame withstands many different loads during operation of the motor grader. For example, the blade exerts axial and torsional loads on the main frame via a drawbar connecting the blade to the front section, and via a center shift assembly connecting the blade directly to the main frame. Likewise, the front and rear sections exert forces on the main frame during turning, powering, or travel over uneven terrain.

In an attempt to provide sufficient stiffness to withstand operational loading of the motor grader and to connect the front section to the rear section, the main frame typically includes a fabricated assembly. For example, U.S. Pat. No. 4,807,461 (the '461 patent) issued to Brimeyer et al. on Feb. 28, 1989, describes a main frame that includes a rear unit, a center unit welded to the rear unit, and a front unit welded to the center unit. The rear unit includes an upper plate, a lower plate, and a pair of left and right side plates welded together. The center unit also includes an upper plate, a lower plate, and left and right side plates welded together. The front unit includes a pair of left and right side plates, a front plate, a rear plate, an upper plate, and gussets secured between the rear plate and the bottom plate of the center unit. Similar to the rear and center units, all of the plates of the front unit, as well as the gussets, are welded together.

While the main frame of the '461 patent may offer sufficient stiffness to withstand operational loading of the motor grader, the fabricated assembly is complex and costly. For example, the numerous parts required for assembly of the main frame of the '461 patent may be expensive to produce and maintain. The main frame of the '461 patent may also require extensive welding that increases labor and manufacturing costs. In addition, the time required to produce the motor grader of the '461 patent may be extensive because of the manufacturing and labor steps involved in the main frame formation and assembly processes.

The present invention is directed to overcoming one or more of the problems set forth above.

### SUMMARY OF THE INVENTION

In one aspect, the present disclosure is directed to a main frame for a work machine having a front section, a rear section, and an operator station. The main frame includes a single formed beam operatively connecting the front section to the rear section. The operator station is connected to the main frame.

In another aspect, the present disclosure is directed to a work machine that includes a front section having at least one traction device. The work machine also includes a rear section having a power source supported by the at least one traction device. The work machine further includes a main frame operatively connecting the front section to the rear section through a single formed beam. The work machine additionally includes an operator station connected to the main frame.

### BRIEF DESCRIPTION OF THE DRAWINGS

FIG. 1 is a diagrammatic illustration of a work machine according to an exemplary embodiment of the present invention;

FIG. 2 is a diagrammatic exploded view illustration of a main frame assembly of a work machine according to an exemplary embodiment of the present invention; and

FIG. 3 is a diagrammatic illustration of a work machine according to an exemplary embodiment of the present invention.

### DETAILED DESCRIPTION

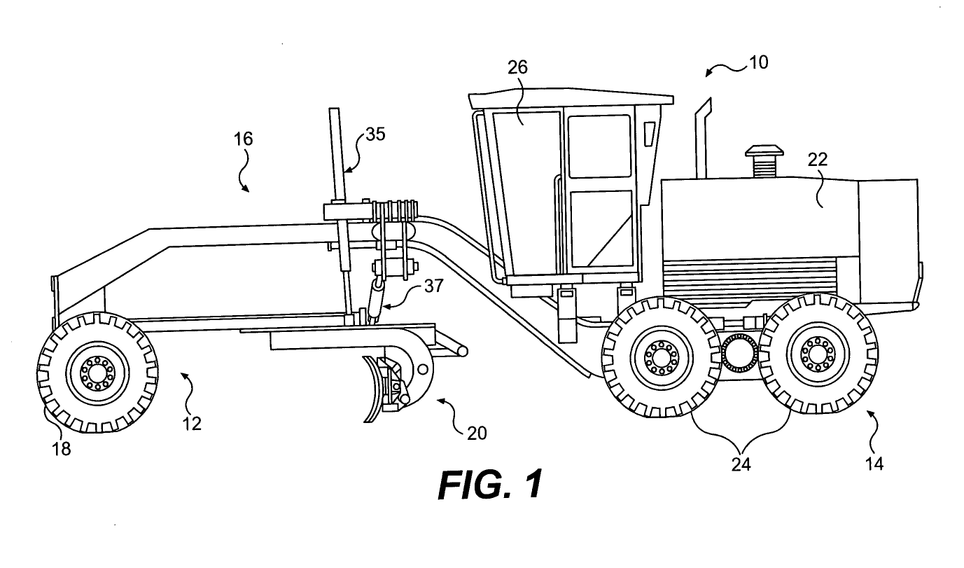

FIG. 1 illustrates an exemplary embodiment of a work machine 10 having a front section 12 and a rear section 14. The front section 12 may include a steerable traction device 18 and may be configured to support a leveling device 20. The rear section 14 may include a power source 22 that drives a traction devices 24. Front section 12 and rear section 14 may be joined together by a main frame assembly 16. An operator station 26 may also be included and connected to main frame assembly 16.

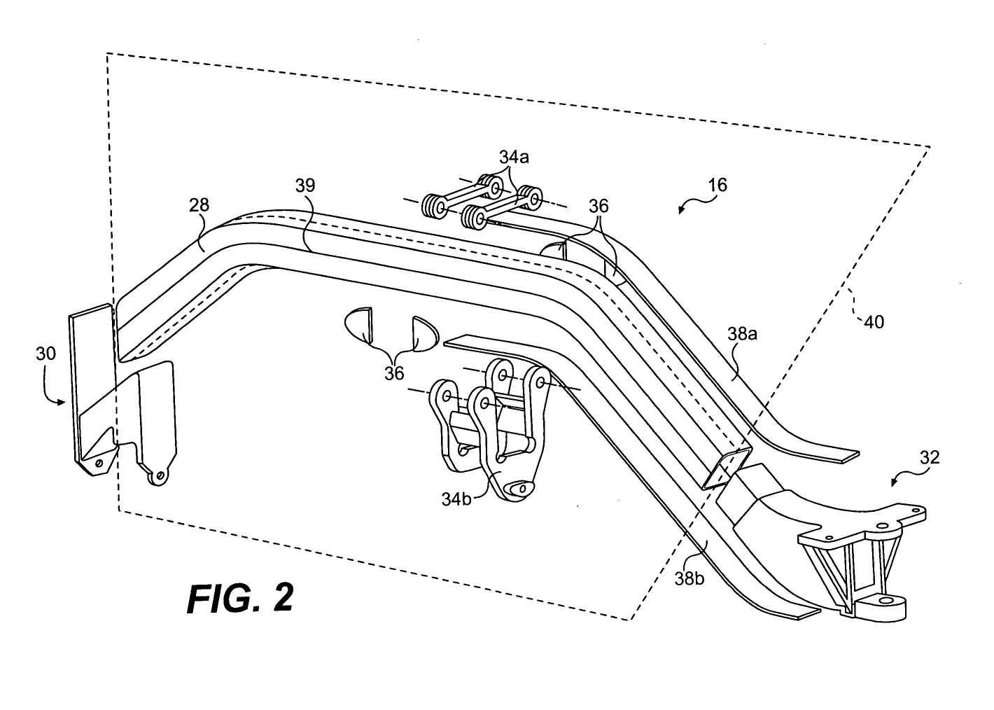

FIG. 2 illustrates the various components of an exemplary main frame assembly 16. Main frame assembly 16 may include a beam 28, a front connection assembly 30, a rear connection assembly 32, a center shift assembly including a top support member 34a and a bottom support member 34b, reinforcement members 36, and a strengthening assembly including a top strengthening member 38a and a bottom strengthening member 38b.

Beam 28 may be, for example, a single formed or shaped beam having a substantially hollow square cross-section. Formed or shaped beams may be single piece beams created by cold or hot methods and may include a single longitudinal weld seam 39. The substantially hollow square cross-section may provide main frame assembly 16 with a substantially high moment of inertia. The cross-section of beam 28 may also be rectangular, round, triangular, or any other appropriate shape. The cross-section of beam 28 may be constant throughout the entire length of beam 28. Beam 28 may include a forward-located bend and a rearward-located bend along a longitudinal axis aligned within a single plane 40 of beam 28. It is also contemplated that beam 28 may include additional or fewer bends, that the bends may be located at any position along the length of beam 28, and that the longitudinal axis may be located in more than one plane.

Beam 28 may be connected to front connection assembly 30 through, for example, welding. Front connection assembly 30 may be configured to articulately connect main frame assembly 16 to front section 12.

Beam 28 may also be connected to rear connection assembly 32 through, for example, welding. Rear connection assembly 32 may include a protruding portion 42 configured to engage interior surfaces of beam 28 to provide additional strength to the welded joint between beam 28 and rear connection assembly 32. It is also contemplated that protruding portion 42 may be absent from rear connection assembly 32, and that front connection assembly 30 may or may not include protruding portion 42. Rear connection assembly 32 may be configured to articulately connect main frame assembly 16 to rear section 14.

As previously noted, the center shift assembly may include two top support members 34a and bottom support member 34b. Each of top support members 34a may be welded to beam 28 and include through holes that align with each other and with through holes in an upper portion of bottom support member 34b. These through holes in the top and bottom support members 34a, 34b may be configured to receive a hydraulic ram assembly 35 (see FIG. 1) connected to leveling device 20 for moving leveling device 20 in a vertical direction relative to the surface being leveled. Bottom support member 34b may include additional through holes configured to receive an additional hydraulic ram assembly 37 (see FIG. 1) connected to leveling device 20 for moving leveling device 20 in a horizontal direction relative to the surface being leveled.

Two reinforcement members 36 may be welded to the outer vertical sides of beam 28 and to the forward and rearward surfaces of the center shift assembly. Reinforcement members 36 may be configured to transfer and distribute the load exerted from leveling device 20 to beam 28, thereby reducing the load on the welded joint between the center shift assembly and beam 28.

As previously noted, the strengthening assembly may include top and bottom strengthening members 38a and 38b, respectively. Top and bottom strengthening members 38a and 38b may include a bend matching that of the upper and lower bent surfaces of beam 28 respectively. Top and bottom strengthening members 38a and 38b may be connected (e.g., welded) to the top and bottom of beam 28, respectively, and to rear connection assembly 32. It is also contemplated that strengthening members 38a and 38b may alternately be connected to front connection assembly 30 or that additional strengthening members may be included and connected to both front and rear connection assemblies 32, 30. In this manner, the strength of beam 28 and the connection between beam 28 and rear connection assembly 32 may be increased.

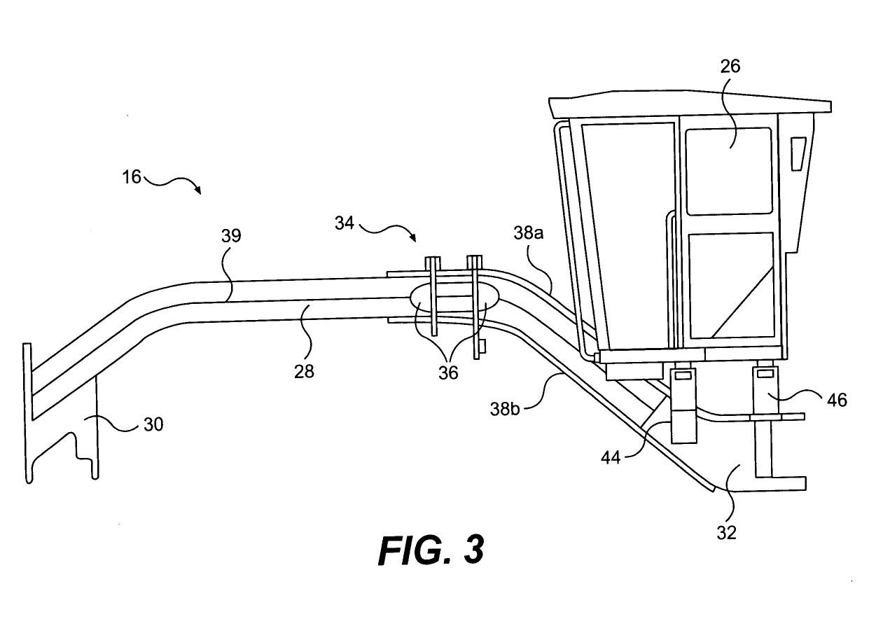

FIG. 3 illustrates an exemplary connection between operator station 26 and main frame assembly 16. Operator station 26 may be connected to main frame assembly 16 via a first mounting member 44 and a second mounting member 46 located on each side of work machine 10 (only one side shown). In particular, first mounting member 44 may connect a forward portion of operator station 26 to a forward portion of rear connection assembly 32, while second mounting member 46 may connect an aft portion of operator station 26 to an aft portion of rear connection assembly 32. It is contemplated that first and second mounting members 44, 46 may include any means for connecting operator station 26 to main frame assembly 16 such as, for example, elastomeric couplings, hydraulic or pneumatic shock absorbers, brackets, and other means known in the art. It is also contemplated that a greater or lesser number of mounting members may be used to connect operator station 26 to main frame assembly 16, that first or second mounting members 44, 46 may alternately connect operator station 26 directly to beam 28, and/or that first and second mounting members 44, 46 may be absent with operator station 26 being connected directly to main frame assembly 16.

### INDUSTRIAL APPLICABILITY

The disclosed main frame assembly may be applicable to any work machine having a front section, a rear section, and a frame connecting the two sections. Main frame assembly 16 may be particularly beneficial in a motor grader application.

Main frame assembly 16 may reduce the complexity and cost of associated work machine 10. Specifically, the uniframe design of main frame assembly 16 may minimize the total part count, the manufacturing and material costs associated with the required parts, and the welding and assembly costs associated with joining the individual parts. The disclosed uniframe design also may minimize the time needed for making and assembling the parts associated with main frame assembly 16. In addition, minimizing the total number of parts and joints may also increase the overall strength and stiffness of main frame assembly 16, thereby providing improved durability of work machine 10.

Operator station 26 being connected to main frame assembly 16 may allow for an improved field of view during articulation. In particular, during articulation, operator station 26 always remains aligned with main frame assembly 16 allowing an operator to easily view the operation of leveling device 20 without requiring the operator to readjust or reorient the viewing angle with respect to the leveling device.

It will be apparent to those skilled in the art that various modifications and variations can be made to the disclosed work machine without departing from the scope of the invention. Other embodiments of the invention will be apparent to those skilled in the art from consideration of the specification and practice of the invention disclosed herein. It is intended that the specification and examples be considered as exemplary only, with a true scope of the invention being indicated by the following claims and their equivalents.

1. A main frame for a work machine having a front section, a rear section, and an operator station, the main frame comprising a single formed beam operatively connecting the front section to the rear section, wherein the operator station is connected to the main frame.

2. The main frame of claim 1, wherein the single formed beam includes a four-sided cross-section.

3. The main frame of claim 1, wherein the single formed beam includes at least one bend.

4. The main frame of claim 1, wherein the single formed beam includes a substantially constant cross-section over an entire length of the beam.

5. The main frame of claim 1, wherein the single formed beam includes a single longitudinal weld seam.

6. The main frame of claim 1, further including:
a center shift assembly operatively connected to the single formed beam; and
at least one reinforcement plate operatively connected to the center shift assembly and the single formed beam and configured to transfer loads from the center shift assembly to the single formed beam.

7. The main frame of claim 6, wherein the center shift assembly includes a first member configured to engage a first side of the single formed beam, and a second member configured to engage a second side of the single formed beam located opposite to the first side.

8. The main frame of claim 1, wherein the single formed beam has a first end and a second end and the main frame further includes:
a first connection assembly operatively connecting the first end to the front section; and
a second connection assembly operatively connecting the second end to the rear section, wherein the operator station is connected to the second connection assembly.

9. The main frame of claim 8, wherein the single formed beam is hollow and at least one of the first and second connection assemblies includes a portion configured to be inserted into the single formed beam.

10. The main frame of claim 8, further including a strengthening assembly operatively connected to the single formed beam and at least one of the first and second connection assemblies.

11. The main frame of claim 10, wherein the strengthening assembly includes:
a first strengthening member operatively connected to one side of the single formed beam and at least one of the first and second connection assemblies; and
a second strengthening member operatively connected to a second side of the single formed beam, and to the at least one of the first and second connection assemblies.

12. A work machine, comprising:
a front section having at least one traction device;
a rear section having:
a power source; and
at least one traction device configured to support the power source;
a main frame operatively connecting the front section to the rear section through a single formed beam; and
an operator station operatively connected to the main frame.

13. The work machine of claim 12, wherein the single formed beam includes a four-sided cross-section.

14. The work machine of claim 12, wherein the single formed beam includes at least one bend.

15. The work machine of claim 12, wherein the single formed beam includes a substantially constant cross-section along an entire length of the single formed beam.

16. The work machine of claim 12, wherein the single formed beam includes a single longitudinal weld seam.

17. The work machine of claim 12, further including:
a center shift assembly operatively connected to the single formed beam; and
at least one reinforcement plate operatively connected to the center shift assembly and the single formed beam and configured to transfer loads from the center shift assembly to the single formed beam.

18. The work machine of claim 12, wherein the single formed beam has a first end and a second end and the main frame further includes:
a first connection assembly operatively connecting the first end to the front section; and
a second connection assembly operatively connecting the second end to the rear section, wherein the operator station is connected to the second connection assembly.

19. The work machine of claim 18, wherein the single formed beam is hollow and at least one of the first and second connection assemblies includes a portion configured to be inserted into the single formed beam.

20. The work machine of claim 18, further including a strengthening assembly operatively connected to the single formed beam and at least one of the first and second connection assemblies.

21. The work machine of claim 20, wherein the strengthening assembly includes:
a first strengthening member operatively connected to one side of the single formed beam and the at least one of the first and second connection assemblies; and
a second strengthening member operatively connected to a second side of the single formed beam and to the at least one of the first and second connection assemblies.

22. A motor grader, comprising:
a front section having at least one traction device;
a rear section having:
a power source; and
at least one traction device configured to support the operator station and the power source;
a main frame operatively connecting the front section to the rear section through a single formed beam having a substantially constant hollow cross-section and a single longitudinal weld seam;
an operator station connected to the main frame;
a center shift assembly operatively connected to the single formed beam; and
at least one reinforcement plate operatively connected to the center shift assembly and the single formed beam and configured to transfer loads from the center shift assembly to the single formed beam.
